(19) United States
(12) Patent Application Publication
(10) Pub. No.: US 2007/0272617 A1
(43) Pub. Date: Nov. 29, 2007

(54) Sand and Animal Waste Separation System

(75) Inventor: Larry W. Denney, Loxahatchee, FL (US)

Correspondence Address: BARNES & THORNBURG LLP, 11 SOUTH MERIDIAN, INDIANAPOLIS, IN, 46204, US

(73) Assignee: Biomass Processing Technology, In

(21) Appl. No.: 11/596,695

(22) PCT Filed: May 16, 2005
(86) PCT No.: PCT/US05/17062

§ 371 Date: Nov. 16, 2006

Related U.S. Application Data
(60) Provisional application No. 60/571,996, filed on May 18, 2004.
(60) Provisional application No. 60/571,959, filed on May 18, 2004.
(60) Provisional application No. 60/572,166, filed on May 18, 2004.
(60) Provisional application No. 60/572,179, filed on May 18, 2004.
(60) Provisional application No. 60/572,187, filed on May 18, 2004.
(60) Provisional application No. 60/572,206, filed on May 18, 2004.
(60) Provisional application No. 60/572,226, filed on May 18, 2004.

(51) Int. Cl. B01D 21/24

(52) U.S. Cl. 210/744; 210/104

(57) ABSTRACT

A system for processing a composition of sand and animal waste includes a first separation tank receiving water from a water source and receiving the composition from a transport. The composition and the water are mixed in the first separation tank to form a liquefied animal waste and sand combination, and to separate and collect the sand from the resulting liquefied animal waste. The liquefied animal waste and the collected sand are separately removed from the first separation tank, and the recovered sand may be reused while the liquefied waste is supplied to a waste storage or processing location. The system may include a second separation tank operable identically to the first separation tank, and control of the two separation tanks may be coordinated such that one of the tanks is being filled while the other is being emptied.

### CROSS REFERENCE TO RELATED APPLICATIONS

This application claims the benefit under 35 U.S.C. 119(e) of U.S. Provisional Applications Ser. Nos. 60/571,996; 60/571,959; 60/572,166; 60/572,179; 60/572,187; 60/572,206 and 60/572,226 filed May 18, 2004, each of which is expressly incorporated herein by reference.

### FIELD OF THE INVENTION

This disclosure relates generally to systems for processing animal waste in the form of a sand and animal waste composition, and more specifically to such systems for separating the sand and animal waste composition into liquefied animal waste and bulk sand suitable for reuse.

### BACKGROUND OF THE INVENTION

The disposal of biomaterial waste, such as animal waste, human waste, and waste from food processing plants, is becoming increasingly difficult. Large quantities of waste are produced every day from families in urban and rural areas and from industrial sources, such as from food processing plants, slaughterhouses, and other industrial sources of organic waste, and from agricultural sources, such as livestock and poultry feeding operations. The waste must be disposed of in a way that protects the environment, in particular air and water, from the pollutants in waste (e.g., phosphorus, nitrogen, and potassium). Common methods of waste disposal presently include land application of animal waste, disposal in sanitary landfills, and disposal by processing in composting plants. However, the large volume of waste being generated cannot be adequately handled by using the presently available methods for waste disposal.

One conventional technique for collecting animal waste in particular includes liquefying the waste and storing it in one or more lagoons for subsequent land application or processing via a waste processing system. It is also conventional to provide a quantity of sand in animal confinement areas or other animal habitation areas as a non-decomposing bedding material that promotes animal comfort. A mixture of sand and animal waste necessarily results. Typically, a quantity of fresh sand is provided in the animal confinement area or other animal habitation area, and after the passage of some time period, e.g., one or more days, the resulting composition of sand and animal waste is removed and a new load of fresh sand is provided. The sand and animal waste composition is typically removed while it is still “dry” matter; e.g. approximately 50% or less animal waste, and it may be collected and transported by conventional machinery, such as a front end loader or other such machinery, to a sanitary land fill or other designated location.

The sand and animal waste combination collection technique just described requires a continuing supply of fresh sand and allocation of valuable land for sanitary land fills. Accordingly, there is a need for a sand and animal waste composition separating system that provides for the recovery of bulk sand for reuse in the animal facility, and that liquefies the animal waste for storage in an existing lagoon and/or for processing via an animal waste processing system.

### SUMMARY OF THE INVENTION

The present invention may comprise one or more of the features recited in the attached claims and the following features and combinations thereof. A system for processing a composition of sand and animal waste may comprising at least one separation tank configured to process the composition by separating the sand from the animal waste and a first transport supplying the composition to the at least one separation tank. A number of sensors may produce sensory information relating to operation of the first transport and operation of the at least one separation tank, and at least one control circuit may be provided to monitor the sensory information. Alternatively or additionally, the at least one control circuit may be configured to control operation of the first transport and the at least one separation tank.

A method for controlling a system for processing a composition of sand and animal waste may comprise directing water from a water source into the at least one separation tank, directing the composition supplied by the first transport to the at least one separation tank, mixing the composition and the water in the at least one separation tank in a manner that forms a liquefied animal waste and sand combination, and that separates the sand from the combination to form liquefied animal waste, removing the liquefied animal waste from the at least one separation tank, and extracting the separated sand from the at least one separation tank.

These and other features of the present invention will become more apparent from the following description of the illustrative embodiments. BRIEF DESCRIPTION OF THE DRAWINGS

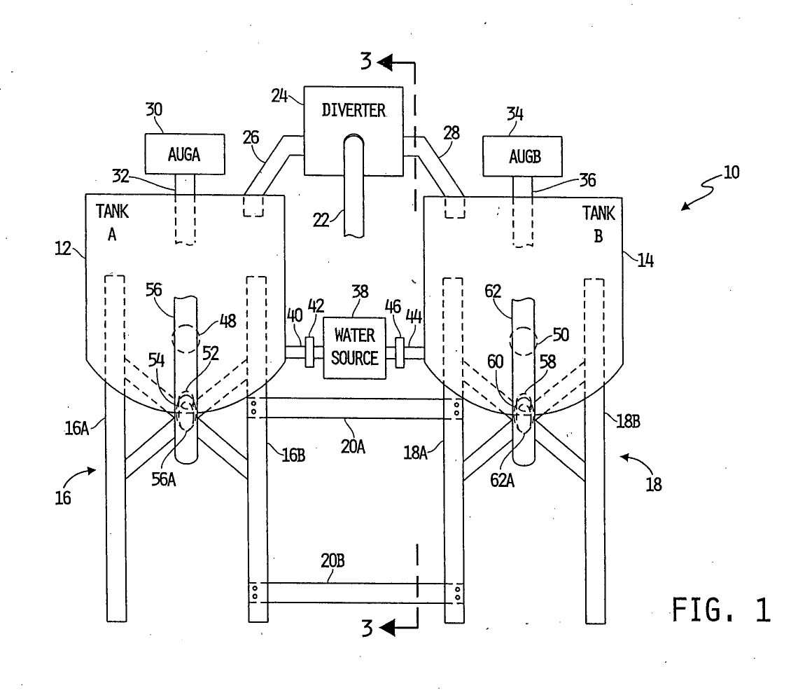

FIG. 1 is a front elevational view of a portion of one illustrative embodiment of a system for separating a sand and animal waste composition into bulk sand and liquefied waste.

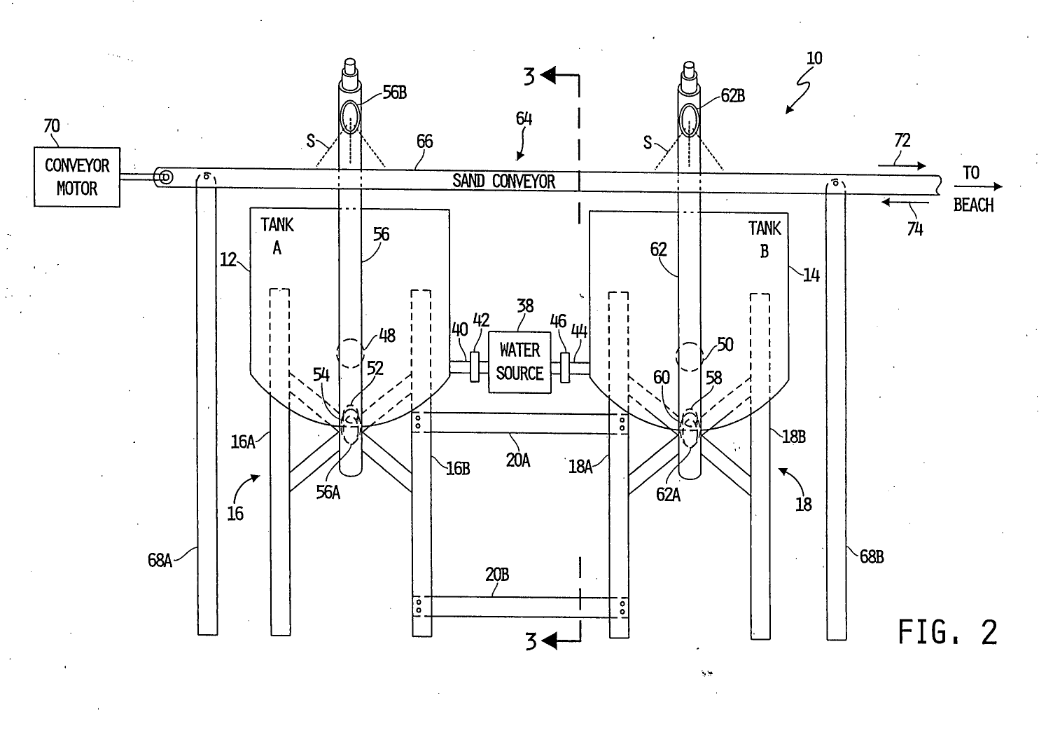

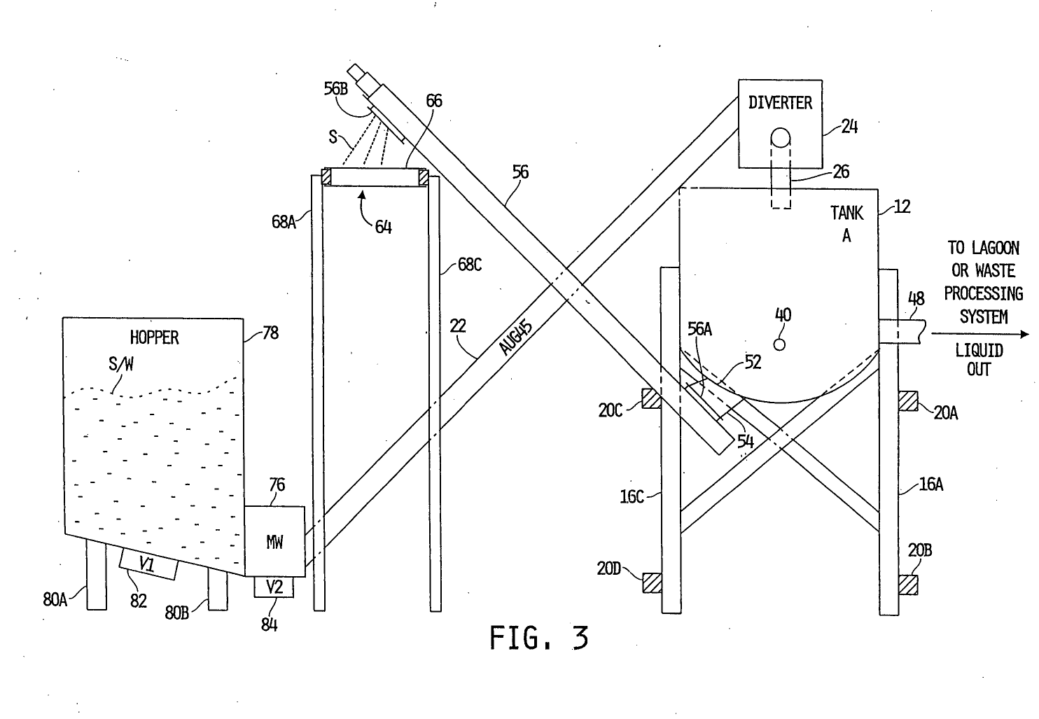

FIG. 2 is a front elevational view of another portion of the system illustrated in FIG. 1.

FIG. 3 is a side elevational view of another portion of the system illustrated in FIGS. 1 and 2, viewed along section line 3.

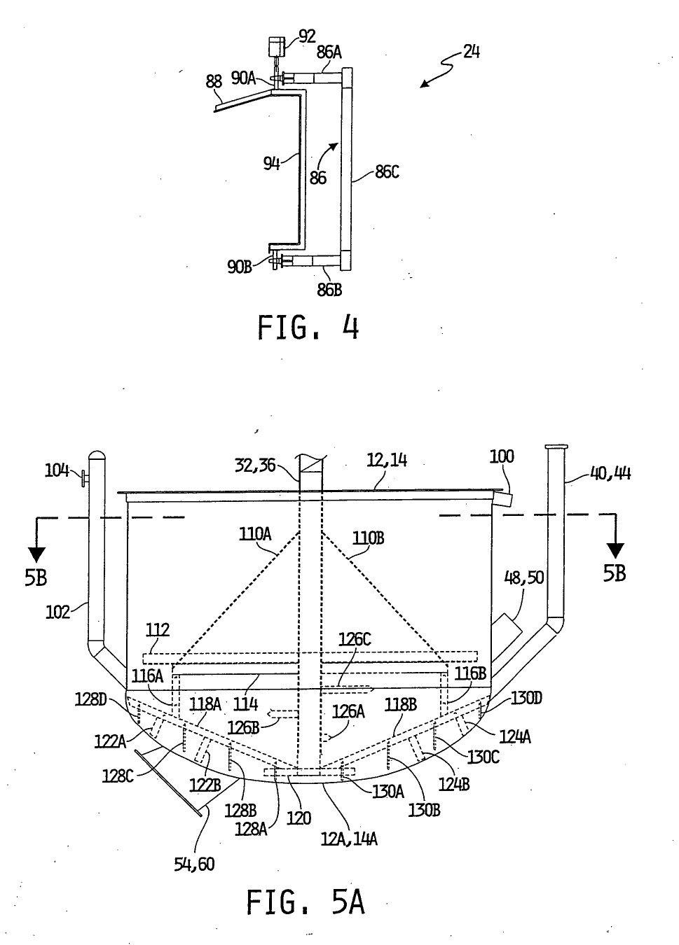

FIG. 4 is a side elevational view of one illustrative embodiment of the diverter of FIGS. 1 and 2.

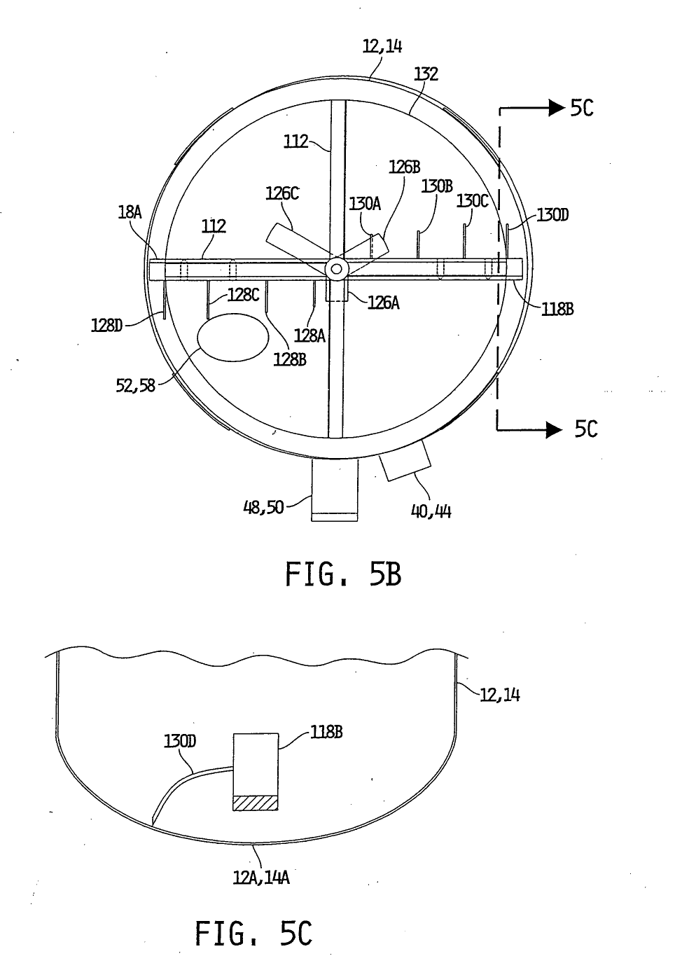

FIG. 5A is a side elevational view of one of the sand removal tanks of FIGS. 1 and 2 showing in phantom one illustrative embodiment of the sand separation auger.

FIG. 5B is a cross-sectional view of the sand removal tank illustrated in FIG. 5A, viewed along section line 5B.

FIG. 5C is a cross-sectional view of the sand removal tank illustrated in FIG. 5B, viewed along section line 5C.

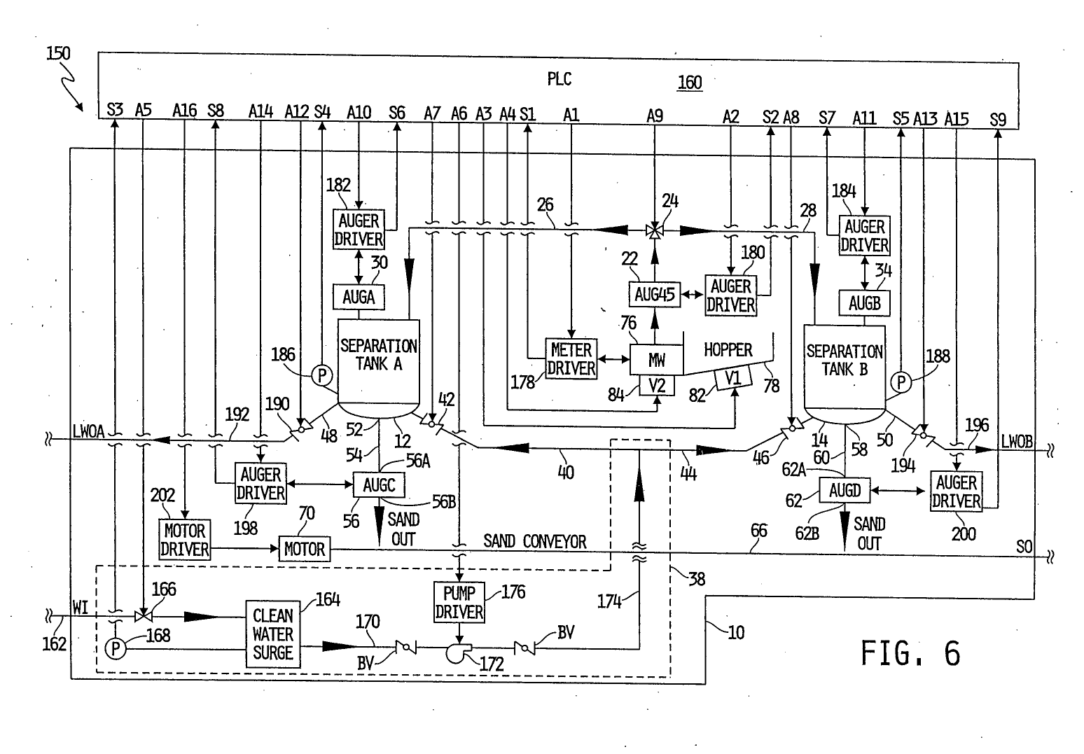

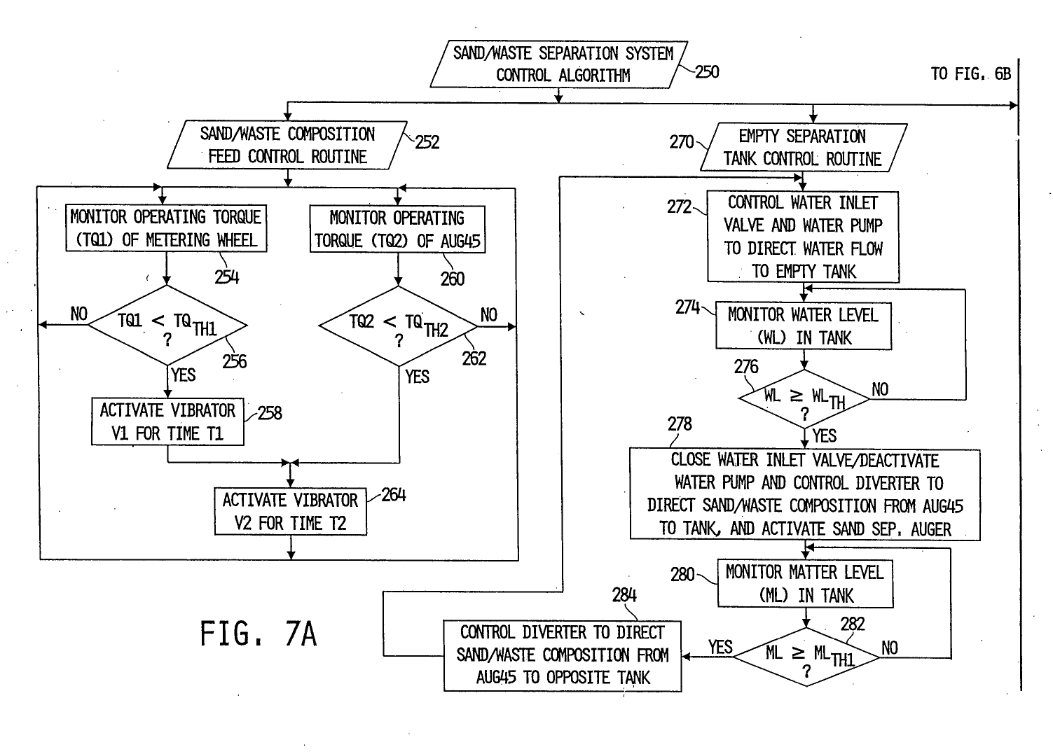

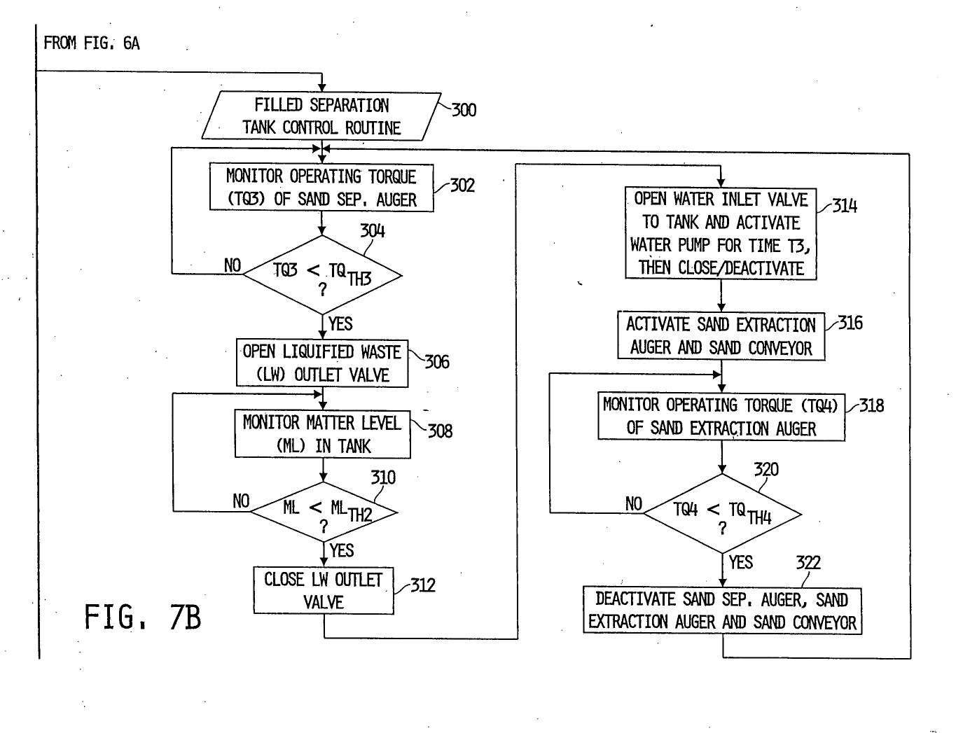

FIG. 6 is a schematic diagram of one illustrative embodiment of a control system for controlling operation of the system of FIGS. 1-4.

FIGS. 7A and 7B show a flowchart of one illustrative embodiment of a software algorithm for controlling the system of FIGS. 1-5C via the control system of FIG. 6.

### DESCRIPTION OF THE ILLUSTRATIVE EMBODIMENTS

For the purpose of promoting an understanding of the principles of this disclosure, reference will now be made to one or more embodiments illustrated in the drawings and specific language will be used to describe the same. It will nevertheless be understood that no limitation of the scope of the disclosure is thereby intended.

Referring to FIG. 1, a front elevational view of a portion of one illustrative embodiment of a system 10 for separating a sand and animal waste composition into bulk sand and liquefied waste is shown. Generally, the sand and animal waste composition separating system 10 is operable to separate the sand and animal waste composition in a manner that provides for the recovery of bulk sand for reuse in the animal facility, and that liquefies the animal waste for storage in an existing lagoon and/or for processing via an animal waste processing system. It will be understood that the sand component of the sand and animal waste composition may include other small and/or dense particles, and the term “sand” as used herein is accordingly intended to include any such other small and/or dense particles.

In the illustrated embodiment, system 10 includes a first separation tank 12 and a second separation tank 14 elevated above the ground or other support structure by support frames 16 and 18 respectively. Support frames 16 includes four support legs 16A-16D, although only two such support legs 16A and 16B are illustrated in FIG. 1, and all of the support legs 16A-16D are secured to each other via a pair of cross members. Support frame 18 similarly includes four support legs 18A-18D, although two such support legs 18A and 18B are shown in FIG. 1, and each of the support legs 18A-18D are secured to each other via a pair of crossing support members. Support frames 16 and 18 are further secured to each other via a number of support members connected therebetween, wherein in two such support members 20A and 20B are illustrated in FIG. 1.

The sand and animal waste composition is supplied to system 10 via a first transport 22 coupled to an inlet of a diverter 24 having a first outlet in communication with separation tank 12 via conduit 26, and a second outlet in communication with tank 14 via conduit 28. The diverter 24 is operable to selectively divert the sand and animal waste composition to separation tanks 12 and 14 via conduits 26 and 28 respectively, and further details relating to the structure and operation of diverter 24 will be described hereinafter with respect to FIGS. 4 and 6.

System 10 further includes a first auger motor 30 coupled to an auger shaft 32 extending into separation tank 12, and a second auger motor 34 coupled to another auger shaft 36 extending into separation tank 14. Details relating to one illustrative structure of augers connected to the auger shafts 32 and 36 will be described in greater detail hereinafter with respect to FIGS. 5A-5C.

System 10 further includes a water source 38 fluidly coupled to a water inlet of tank 12 via conduit 40, and fluidly coupled to a water inlet of tank 14 via conduit 44. A control valve 42 is disposed in-line with conduit 40, and another control valve 46 is disposed in-line with conduit 44, wherein valves 42 and 46 are controllable to selectively provide water to separation tanks 12 and 14. Separation tank 12 further includes a liquefied waste outlet 48, and separation tank 14 also includes a liquefied waste outlet 50, wherein outlets 48 and 50 are each defined through the respective separation tanks 12 and 14. In the illustrated embodiment, each of tanks 12 and 14 have cylindrically shaped sides with open tops and dome-shaped bottoms defining sand outlets 52 and 58 respectively, although the tanks 12 and 14 may alternatively be provided with shapes other than cylindrical. The sand outlet 52 of separation tank 12 is coupled to a sand inlet 56A of a sand extraction auger 56 via a sand outlet conduit 54, and the sand outlet 58 of separation tank 14 is similarly coupled to a sand inlet 62A of another sand extraction auger 62 via a sand outlet conduit 60.

FIG. 2 is another front elevational view of system 10 illustrating additional structure relating to the sand extraction augers 56 and 62. In this view, details relating to augers 30 and 34, as well as the diverter 24 and related structure, are omitted for clarity of illustration. Referring to FIG. 2, the sand extraction augers 56 and 62 are illustrated as 45° augers defining sand outlets 56B and 62B at opposite ends from the sand inlets 56A and 56B respectively. It will be appreciated, however, that either or both of the sand extraction augers 56 and 62 may alternatively be implemented as any conventional matter transport system or unit which may or may not be positioned at 45° relative to horizontal or vertical. In any case, the system 10 illustrated in FIG. 2 further includes a second transport, which is illustrated in the form of a sand conveyor 64, positioned under the sand outlets 56B and 62B of the sand extraction augers 56 and 62 respectively such that sand exiting auger outlets 56B and 62B is deposited onto a conveyor belt or other conveyor transport mechanism 66. The conveyer belt 66 travels in the direction of arrow 72 to carry the extracted sand to a “beach” which may be any sand storage area or facility. The sand conveyor 64 is supported by a number of support legs, wherein two such support legs 68A and 68B are illustrated in FIG. 1. The conveyor belt 66 is driven by a conveyor motor 70 such that the belt 66 travels in the direction of arrow 72 and returns in the direction of arrow 74.

Referring now to FIG. 3, a side elevational view of system 10, as viewed along section line 3 of FIGS. 1 and 2, is shown illustrating additional components comprising system 10. With respect to the components of system 10 shown in FIGS. 1 and 2, FIG. 3 illustrates an additional support leg 16C forming part of the tank support structure 16, as well as an additional support leg 68C supporting the sand conveyors 64. Additional support members 20C and 20D are also shown in cross-section, wherein the support members 20C and 20D are also secured to a support leg 18C (not shown) of the tank support structure 18.

The first transport 22 has an inlet coupled to an outlet of a metering wheel or other metering mechanism 76 having an inlet coupled to, or disposed within, a sand and animal waste composition holding container or hopper 78. Hopper 78 is supported by a pair of support legs 80A and 80B, and is illustratively configured with a sloping bottom to direct the sand and animal waste composition contained therein toward the inlet of the metering wheel 76. In the illustrated embodiment, the first transport 22 is a 45° auger coupled between the outlet of the metering wheel 76 and the inlet of the diverter 24 and operable to transport the sand and animal waste composition from the metering wheel 76 to the diverter 24. It will be appreciated, however, that the first transport 22 may alternatively be implemented as any conventional matter transport system or unit which may or may not be positioned at 45° relative to horizontal or vertical. In any case, the hopper 78 includes a first vibrator 82 attached thereto, and the metering wheel 76 has a second vibrator 84 attached thereto. Vibrators 82 and 84 are operable as will be described hereinafter with respect to FIGS. 7A and 7B, to vibrate the bottom of the hopper 78 and the structure of the metering wheel 76 to facilitate feeding of the sand and animal waste composition held in the hopper 78 toward and through the metering wheel 76, and toward and through the first transport 22. In the embodiment illustrated in FIGS. 1-3, the sand and animal waste composition is transported from the animal storage facility to the hopper 78 via conventional hauling or transport machinery, and system 10 is operable as described herein to process the composition of sand and animal waste by separating the composition into bulk sand and liquefied waste, recovering the bulk sand via sand conveyor 64 for reuse in the animal storage facility and transporting the liquefied animal waste to a liquid waste storage or processing system.

Referring now to FIG. 4, one illustrated embodiment of the diverter 24 of FIGS. 1 and 3 is shown. In the illustrated embodiment, the diverter 24 includes a mounting bracket 86 having a pair of opposing bracket legs 68A and 68B each having one end secured to a bracket mounting portion 86C and an opposite free end. Bracket mounting portion 86C is secured to a suitable support structure (not shown) to position diverter 24 above the separation tanks 12 and 14 as illustrated in FIGS. 1 and 3. Diverter 24 further includes a diverting member 88 having cylindrical pins 90A and 90B extending from opposite ends thereof and pivotably attached to the free ends of bracket arms 86A and 86B respectively. An air actuator 92 is coupled to pin 90A, and is controllable to selectively rotate the diverter member 88 about the longitudinal axis of pins 90A and 90B. The diverter member 88 includes a diverter face 94 positioned generally opposite to the composition outlet of the first transport 22 (see FIGS. 1 and 3), and the diverter face 94 is configured to divert the composition supplied by the first transport 22 to either of conduits 26 or 28. The diverter member 88 is controllable between two positions, wherein the diverter face 94 directs the composition supplied by the first transport 22 to conduit 26 when the diverter member 88 is in one position, and directs the composition supplied by the first transport 22 to conduit 28 when the diverter member 88 is in the other position.

Referring now to FIG. 5A, a side elevational view of one of the separation tanks 12 or 14 of FIGS. 1 and 2 is shown with one illustrative embodiment of an auger structure connected to auger shaft 32 or 36 shown in phantom, as well as some of the structural details relating to the separation tank 12 or 14. Regarding the separation tank details, each tank 12 and 14 includes a liquid overflow outlet 100 which may be coupled to a waste recovery tank (not shown) operable to re-route its contents at a convenient time back to tank 12 and/or tank 14, or instead may be routed to a conventional waste disposal system or apparatus. Tank 12 or 14 further includes a capped extension pipe extending from a sidewall thereof and having an outlet port 104 configured for fluid connection to a pressure sensor for sensing the pressure within tank 12 or 14. In the illustrated embodiment, the interface between the extension pipe 102 and the tank 12 or 14, as well as the interface between the liquid waste outlet 48 or 50 and tank 12 or 14, is defined through the sidewall of tank 12 or 14 just above the domed portion 12A or 14A. The domed portion 12A or 14A is sized to collect the sand in any one load of sand and animal waste composition in tank 12 or 14, and the positioning of the interfaces of extension tube 102 and liquid waste outlet port 48 or 50 thus corresponds to approximately the lowest level of liquid within the tank 12 or 14. The interface between the water inlet conduit 40 or 44 and the tank 12 or 14, on the other hand, is defined through the domed portion 12A or 12B of tank 12 or 14 to allow re-hydrating of settled sand within the domed portion 12A or 12B after the liquid waste has been removed from tank 12 or 14 as will be described in greater detail with respect to FIGS. 7A and 7B.

With regard to the illustrated structure of the auger connected to the auger shaft 32 or 36, a plate or bar 112 extends transversely from auger shaft 32 or 36, and a pair of support rods 110A and 110B extend from shaft 32 or 36 and attach to plate or bar 112 adjacent opposite ends thereof. A second plate or bar 114 extends downwardly from plate or bar 112 and is attached at opposite ends to a pair of angled plates or bars 118A and 118B via support plates or bars 116A and 116B. Each of the angled plates or bars 118A and 118B has one end attached to a bottom plate 120 affixed to the end of the auger shaft 32 or 36 and an opposite free end. Support plates or bars 116A and 116B attach to the angled plates or bars 118A and 118B near the free ends thereof. A pair of mixing tines 122A and 122B extend downwardly from the angled plate or bar 118A toward the bottom surface of the domed portion of 112A or 114A of tank 12 or 14, and a pair of mixing tines 124A and 124B similarly extend from the angled plate or bar 118B toward the bottom surface of the domed portion 12A or 14A of tank 12 or 14. Additionally, three mixing tines 126A, 126B and 126C extend generally transversely away from the auger shaft 32 or 36 between the end plate 120 and bar or plate 114.

Additionally, four flexible mixing tines 128A-128D extend downwardly from the angled plate or bar 118A toward the bottom surface of the domed portion 12A or 14A of tank 12 or 14, and four flexible mixing tines 130A-130D similarly extend from the angled plate or bar 118B toward the bottom surface of the domed portion 12A or 14A of tank 12 or 14. As illustrated in FIG. 5B, the flexible mixing tines 128A-128D and the flexible mixing tines 130A-130D extend from opposite sides of the respective angled bars or plates 118A and 118B, while all such mixing tines 128A-128D and 130A-130D further extend downwardly toward the bottom surface of the domed portion 12A or 14A of tank 12 or 14 as illustrated in FIG. 5C. Each of the mixing tines 122A, 122B, 124A, 124B, 126A, 126B and 126C are sized to agitate the sand settling into and being collected by the domed portion 12A or 14A to keep the sand from becoming too tightly packed. The mixing tines 128A-128D and 130A-130D are sized and configured to allow flexing of these tines upon startup of the auger 30 or 34 to provide for mixing of the collected sand while avoiding breakage of the various mixing tines 122A-122B, 124A-124B, 128A-128D and 130A-130D. The overall structure of the auger connected to the auger shaft 32 and 36 as just described is configured to create a lateral flow of liquefied waste about the tank 12 or 14 while allowing the sand in the mixture of sand, animal waste and water to drop out of the composition and collect in the domed portion 12A or 14A of tank 12 or 14. Specifically, the sand separation auger connected to the auger shaft 32 or 36 is configured to displace sand horizontally while simultaneously creating a void of sand behind the sand separation auger as it rotates within the respective tank 12 or 14. This “void” then, by the initial displacement of sand, fills with water. As the sand then begins to displace the water that has filled the void, a net lifting force is created that tends to buoy upwardly the larger, lighter animal waste in a relatively high velocity upward water stream, thereby separating the animal waste from the sand with the animal waste suspended above the sand flowing laterally beneath it.

Referring now to FIG. 6, a schematic diagram of one illustrative embodiment of a control system 150 for controlling operation of the system 10 of FIGS. 1-5C is shown. Control system 150 includes a number of sensors for sensing operating parameters related to the operation of system 10, as well as a number of actuators for controlling operation of system 10. Control of such actuators is accomplished via one or more control circuits configured to execute such control. In one embodiment, for example, electronic control of the system 10 accomplished via one or more conventional programmable logic circuits (PLCs) distributed throughout the system 10, wherein such PLCs have a number of inputs for receiving sensory data produced by one or more sensors and a number of outputs configured to control one or more system actuators. The number of PLCs include microprocessor-based controllers and on-board memory, and may be configured to communicate with each other yet operate independently. In one illustrative embodiment, such PLCs are commercially available through ControLLogix, Inc. In the embodiment of system 10 illustrated in FIG. 6, one such programmable logic circuit 160 shown. It will be understood that only a single PLC circuit 160 is shown in FIG. 6 for ease of illustration and subsequent description, and that a practical implementation of system 10 may include any number of such PLCs distributed throughout the system 10.

In an alternate embodiment, the PLC circuit 160 may be configured to include a number of analog-to-digital and a number of digital-to-analog converters. In this embodiment, a PLC circuit may also be provided and operable to control the operation of the system 10. The PLC circuit in this alternate embodiment may be microprocessor-based, and include a memory having stored therein a number of software control algorithms. The microprocessor portion of such a PLC circuit may be configured to execute such software algorithms to control operation of the system 10. The PLC circuit may further include a number of digital inputs and outputs (I/O) each electrically connected to corresponding I/Os of any number of programmable logic controllers. Such PLC circuits in this embodiment, are configured to digitize analog signals provided by sensors associated with the system 10 to the PLC circuit, and to convert digital output signals from the PLC circuit to corresponding analog control signals for controlling actuators associated with the system 10.

For ease of illustration and description, electronic control of the various components of the sand and animal waste composition separation system 10 will be described herein as being accomplished via the single illustrated PLC circuit 160, it being understood that alternate forms of such control may alternatively or additionally be implemented. In any case, the system 10 includes a water inlet conduit 162 fluidly coupled to a conventional water source (not shown), and coupled via a control valve 166 to a clean water surge tank 164. The control valve 166 is electrically connected to an actuator output A5 of PLC circuit 160, wherein the PLC circuit 160 is operable to control the operation of control valve 166 by producing an appropriate control signal at output A5. A pressure sensor 168 is fluidly coupled to the clean water surge tank 164, and is electrically connected to a sensor input, S3, of the PLC circuit 160. The PLC circuit 160 is operable to monitor the water level within the clean water surge tank 164 by monitoring the pressure signal produced by pressure sensor 168, and to control the control valve 166 based on the pressure signal produced by pressure sensor 168 to maintain a desired level of water within the clean water surge tank 164. A water outlet of the clean water surge tank 164 is coupled to an input of a water pump 172 via a conduit 170 having a butterfly valve, BV, disposed in-line therewith. An outlet of water pump 172 is coupled via conduit 174 and through another butterfly valve, BV, to water inlet pipes 40 and 44 leading to tanks 12 and 14 respectively as illustrated in FIG. 1. The butterfly valves, BV, are mechanical valves that are normally open, and that may be closed to allow maintenance or replacement of the water pump 172. The water pump 172 is electrically connected to a pump driver 176 that is electrically connected to an actuator output, A6, of the PLC circuit 160. Operation of the water pump 172 is controlled by the PLC circuit 160 via control of the pump driver 176 in a conventional manner. The foregoing components 162-176 represent the water source 38 illustrated in FIG. 1, and these components are accordingly surrounded by a dash-line enclosure 38 in FIG. 5.

The water inlet line 40 is coupled through the control valve 42 to the water inlet of separation tank 12, and control valve 42 is electrically connected to an actuator output, A7, of PLC circuit 160. Water line 44 is similarly coupled through control valve 46 to the water inlet of separation tank 14, and the control valve 46 is electrically connected to an actuator output, A8, of the PLC circuit 160. The PLC circuit is configured to control the operation of the control valves 42 and 44 by producing appropriate control signals at outputs A7 and A8 respectively. Generally, the PLC circuit 160 is operable, as will be described in greater detail with respect to FIGS. 6A and 6B, to control the operation of the water pump 172 and the control valves 42 and 46 to control the quantity, and timing, of water supplied to each of the separation tanks 12 and 14.

Schematic representations of the hopper 78, metering wheel 76, first transport 22 and diverter 24 are included in FIG. 5 to illustrate control of these components. For example, the first vibrator 82 is electrically connected to an actuator output, A3, of PLC circuit 160, and the second vibrator 84 is electrically connected to another actuator output, A4, of PLC circuit 160. The PLC circuit 160 is configured to control operation of the vibrators 82 and 84 by producing appropriate control signals at outputs A2 and A3 respectively. The metering wheel 76 is driven by a conventional meter driver 178 that is electrically connected to an actuator output, A1, of PLC circuit 160 and further electrically connected to a sensor input, S1, of PLC circuit 160. The first transport 22, which is implemented in FIGS. 1 and 3 in the form of a 45° auger, is driven by a conventional auger driver 180 that is electrically connected to an actuator output, A2, of PLC circuit 160, and also electrically connected to a sensory input, S2, of PLC circuit 160. The meter driver 178 and the auger driver 180 are each responsive to actuator control signals supplied by the PLC circuit 160 at outputs A1 and A2 respectively to drive the meter wheel 76 and 45° auger 22 respectively. Each of the meter driver 178 and the auger driver 180 further include “sensors” for determining the operating torque of each of these devices, and the sensor signals provided to sensor inputs S1 and S2 are accordingly torque feedback signals that correspond to the operating torques of the metering wheel 76 and 45° auger 22 respectively. The “sensors” included within each of the meter driver 178 and auger driver 180 may be conventional strain-gauge type torque sensors, or may alternatively be other sensors producing information from which the PLC circuit 160 may derive or infer a torque value. For example, one such virtual torque sensor may be or include a current sensor producing a signal indicative of drive current being drawn by the driver device, and/or a position or speed sensor producing a signal corresponding to the speed or position of the driven device. In any such case, the PLC circuit 160 may include one or more conventional software algorithms responsive to such sensor information and/or to other known information relating to the physical properties and/or operation of the driven device, to compute or estimate an operating torque value. In any case, the metering wheel 76 is operable to supply the sand and animal waste composition from the hopper 78 to the 45° auger 22, which is in turn operable to supply the composition from the metering wheel 76 to the diverter 24. The diverter 24 is electrically connected to an actuator output, A9, of PLC circuit 160, and the PLC circuit 160 is operable as described hereinabove to selectively divert the composition to the separation tanks 12 and 14 via conduits 26 and 28 respectively by producing an appropriate control signal at output A9.

The separation auger 30 of separation tank 12 is electrically connected to another auger driver 182, which is electrically connected to an actuator output, A10, of PLC circuit 160, and which is further electrically connected to a sensor input, S6, of PLC circuit 160. The separation auger 34 of separation tank 14 is likewise electrically connected to another auger driver 184, which is electrically connected to an actuator output, A11, of PLC circuit 160, and which is further electrically connected to a sensor input, S7, of PLC circuit 160. Both of the auger drivers 182 and 184 are conventional in their operation, and are responsive to control signals produced by PLC circuit 160 at outputs A10 and A11 respectively to drive separation auger 30 and separation auger 34 respectively. Each auger driver 182 and 184 is further operable as described above with respect to auger driver 180, to provide PLC circuit 160 with information relating to the operation torque of separation auger 30 and separation auger 34 at sensor inputs S6 and S7 respectively.

System 10 further includes a pressure sensor 186 arranged in fluid communication with separation tank 12, and electrically connected to a sensor input, S4, of PLC circuit 160. Another pressure sensor 188 is arranged in fluid communication with separation tank 14, and is electrically connected to a sensor input, S5, of PLC circuit 160. Pressure sensors 186 and 188 provide the PLC circuit 160 with information relating to the pressure within separation tank 12 and pressure within the separation tank 14 respectively, and the PLC circuit 160 is operable in a known manner to process this pressure information and determine therefrom the levels of liquid or liquefied matter within the separation tanks 12 and 14 respectively. Alternatively, each tank 12 and 14 may include one or more other conventional level sensors configured to provide PLC circuit 160 with information relating to one or more liquid or liquefied matter thresholds within tanks 12 and 14.

The liquid waste outlet of separation tank 12 is coupled through a control valve 190 to a liquid waste outlet conduit 192, which defines a first liquid waste outlet, LWOA, of system 10. The control valve 190 is electrically connected to an actuator output, A12, of PLC circuit 160, and the PLC circuit 160 is configured to control the operation of the control valve 190 by producing an appropriate control signal at output A12. The liquid waste outlet 50 of separation tank 14 is likewise coupled through a control valve 194 to a liquid waste outlet conduit 196, which defines a second liquid waste outlet, LWOB, of system 10. The control valve 194 is electrically connected to an actuator output, A13, of PLC circuit 160, and the PLC circuit 160 is configured to control the operation of the control valve 194 by producing an appropriate control signal at output A13. Control valves 190 and 194 are responsive to the control signals produced by PLC circuit 160 at outputs A12 and A13 to control the flow and flow timing of liquefied waste removal from the separation tanks 12 and 14 respectively. The liquid waste outlets LWOA and LWOB may be combined to produce a continuous flow of liquefied waste out of the system 10. As described hereinabove, for example, the liquid waste outlets, LWOA and LWOB, may be routed to an existing liquid waste lagoon, or may instead be routed to a liquid waste processing system. An example of one such liquid waste processing system is disclosed in each of PCT Applications Serial. Nos. PCT/US2005/______, entitled SYSTEM FOR PROCESSING A BIOMATERIAL WASTE STREAM (attorney docket no. 35479-77858), PCT/US2005/______, entitled FLOCCULATION METHOD AND FLOCCULATED ORGANISM (attorney docket no. 35479-77852), PCT/US2005/______, entitled FERMENTER AND FERMENTATION METHOD (attorney docket no. 35479-77851), PCT/US2005/______, entitled SYSTEM FOR TREATING BIOMATERIAL WASTE STREAMS (attorney docket no. 35479-77848), and PCT/US2005/______, entitled SYSTEM FOR REMOVING SOLIDS FROM AQUEOUS SOLUTIONS (attorney docket no. 35479-77847), all of which are assigned to the assignee of the present invention, and the disclosures of which are all incorporated herein by reference. In such a system, the system 10 illustrated and described herein may be the source of liquefied waste, and/or may be a component supplying liquefied waste to a liquefied waste source.

The sand extraction auger 56, which is implemented in FIGS. 1-3 in the form of a 45° auger, has a sand inlet 56A coupled to the sand outlet 52 of separation tank 12 via a sand conduit 54 and a sand outlet 56B, and is electrically connected to another conventional auger driver 198, which is electrically connected to an actuator output, A14, of PLC circuit 160, and which is further electrically connected to a sensor input, S8, of PLC circuit 160. Likewise, the sand extraction auger 62, which is implemented in FIGS. 1-3 in the form of a 45° auger, has a sand inlet 62A coupled to the sand outlet 58 of separation tank 14 via a sand conduit 60 and a sand outlet 62B, and is electrically connected to another conventional auger driver 200, which is electrically connected to an actuator output, A15, of PLC circuit 160, and which is further electrically connected to a sensor input, S9, of PLC circuit 160. The auger drivers 198 and 200 are responsive to control signals produced by PLC circuit 160 at outputs A14 and A15 respectively to drive augers 56 and 62 respectively. The auger drivers 198 and 200 are further configured to supply torque feedback signals to PLC circuit 160, as described hereinabove, to provide PLC circuit 160 with the information from which the operating torques of augers 56 and 62 respectively can be determined.

The second transport, which is implemented in the system 10 illustrated in FIGS. 1-3 as a sand conveyor 66, is driven by a motor 70 electrically connected to a motor driver 202, which is electrically connected to an actuator output, A16, of PLC circuit 160. Motor driver 202 is a conventional motor driver and is responsive to the actuator control signal provided by PLC circuit 160 at output A16 to drive the sand conveyor motor 70. The sand conveyor defines the sand output, SO, of system 10.

Referring now to FIGS. 7A and 7B, a flow chart of one illustrative embodiment of a software control algorithm 250 for controlling the system 10 of FIGS. 1-5C via the control system 150 of FIG. 6 is shown. Control algorithm 250 is stored in a memory unit (not shown) of the PLC circuit 160, and in the illustrated embodiment control algorithm 250 includes three independently operating routines. One such routine is a sand/waste composition feed control routine 252 having a first step 254 at which the PLC circuit 160 is operable to monitor the operating torque, TQ1, of the metering device 76. The PLC circuit 160 is operable to execute step 254 by monitoring the torque feedback signal supplied by the meter driver 178 to the sensor input, S1, of PLC circuit 160. Thereafter at step 256, the PLC circuit 160 is operable to compare the operating torque, TQ1, to a threshold torque value, TQ_{TH1}. If the PLC circuit 160 determines that TQ1 is greater than or equal to TQ_{TH1}, algorithm execution loops back to step 254. If, however, the PLC circuit 160 determines at step 256 that TQ1 is less than TQ_{TH1}, algorithm execution advances to step 258 where PLC circuit 160 is operable to activate the first vibrator 82 for a time duration T1. Thereafter at step 264, the PLC circuit 160 is operable to activate the second vibrator 84 for a time period T2. From step 264, algorithm 252 loops back to step 254.

Control routine 252 further includes step 260 to be executed contemporaneously with step 254, wherein the PLC circuit 160 is operable to monitor the operating torque TQ2, of the first transport 22. In the illustrated embodiment, the PLC circuit 160 is operable to execute step 260 by monitoring the torque feedback signal provided by auger driver 180 to the sensor input, S2, of PLC circuit 160. Thereafter at step 262, the PLC circuit 160 is operable to compare the operating torque value, TQ2, to a threshold torque value TQ_{TH2}. If the PLC circuit 160 determines that TQ2 is greater than or equal to TQ_{TH2}, execution of the control routine loops back to step 260. If, however, the PLC circuit 160 determines at step 262 that TQ2 is less than TQ_{TH2}, execution of the control routine 252 advances to step 264.

Control routine 252 is included within the control algorithm 250 to facilitate a consistent flow of the sand and animal waste composition from the first transport 22 to the diverter 24. In this regard, if the operating torque of the metering wheel or device 76 is less than TQ_{TH1}, it is assumed that the hopper 78 has therein a sufficient quantity of the sand and animal waste composition, but that an insufficient quantity of the composition is available to the inlet of the metering wheel 76 and/or that the metering wheel inlet is clogged or blocked. In either case, the PLC circuit 160 is responsive to the condition TQ1 less TQ_{TH1} to activate both of the first and second vibrators 82 and 84 for time periods T1 and T2 respectively. If the operating torque of the metering wheel 76 is within an expected range, but the operating torque of the first transport 22 is less than TQ_{TH2}, it is assumed that the metering wheel 76 is being fed a sufficient quantity of the sand and animal waste composition, but is otherwise clogged or blocked and unable to feed the composition to the first transport 22. In this case, the PLC circuit 160 is operable to activate only the second vibrator 84 for the time period T2. The time periods T1 and T2 may be any desired duration.

Control algorithm 250 further includes an independently executing “empty separation tank” control routine 270 operable to control the filling of either the separation tank 12 or separation tank 14 with a combination of the sand and animal waste composition and water. Control routine 270 begins at step 272 where the PLC circuit 160 is operable to control the water inlet valve 42 or 46 and the water pump 172 to direct water flow to whichever of the separation tanks 12 and 14 is currently empty. At the start up of system 10, both tanks 12 and 14 will naturally be empty, and the first execution of control routine 270 will typically require a selection of which of the tanks 12 and 14 to first be filled. In any case, step 272 advances to step 274 where the PLC circuit 160 is operable to monitor the water level, WL, in the tank 12 or 14 being filled. The PLC circuit 160 is operable to execute step 274 by monitoring the pressure signal produced by the pressure sensor 186 or 188 of tanks 12 and 14 respectively, and to process the pressure signal in a conventional manner to determine WL. The execution of control routine of 270 advances from step 274 to step 276 where the PLC circuit 160 is operable to compare WL to a threshold water level WLTH. If WL is less than WLTH, the control routine 270 loops back to step 274. If, however, the PLC circuit 160 determines at step 276 that WL is greater than WLTH, the control routine 270 advances to step 278 where the PLC circuit 160 is operable to close the water inlet valve 42 or 46, deactivate the water pump 172, and control the diverter 24 to direct the sand and animal waste composition from the first transport 22 to the tank 12 or 14 being filled. Closing the water inlet valve 42 or 46 and deactivating the water pump 172 stops the supply of water to the tank 12 or 14 being filled, and the PLC circuit 160 is operable to control the diverter 24 as described hereinabove to an appropriate position to direct the sand and animal waste composition to the tank 12 or 14 being filled. The water level, WL_{TH} is selected to pre-fill the tank 12 or 14 with a sufficient amount of water that will result in a desired liquid consistency when the sand/animal waste composition is thereafter added to the tank 12 or 14. Following step 278, control routine 270 advances to step 280 where the PLC circuit 160 is operable to monitor the matter level, ML, within the tank 12 or 14 being filled. In the illustrated embodiment, the PLC circuit 160 is operable to execute step 280 by monitoring the pressure signal produced by the appropriate pressure sensor 186 or 188, and the PLC circuit 160 is operable to process this pressure signal in a conventional manner to determine ML. Following step 280, the PLC circuit 160 is operable at step 282 to compare ML to a matter level threshold, ML_{TH1}, wherein ML_{TH1} corresponds to a level of matter within tank 12 or 14 at which the tank 12 or 14 is considered to be sufficiently full of the combination of water and sand/waste composition. If ML is less than ML_{TH1}, the execution of control routine 270 loops back to 280. If, on the other hand, the PLC circuit 160 determines that ML is greater than or equal to ML_{TH1}, control routine 270 advances to step 284 where the PLC circuit 160 is operable to control the diverter 24 to its opposite position to direct the sand and animal waste composition supplied by the first transport 22 to the opposite tank 12 or 14. From step 284, execution of control routine 270 loops back to step 272 where the PLC circuit 160 is operable to execute control routine 270 to fill the opposite tank 12 or 14.

The empty separation tank control routine 270 is included within the control algorithm 250 to control the filling of an empty one of the separation tanks 12 or 14 with a combination of the sand and animal waste composition and water. The combination is mixed by activating an appropriate one of the sand separation augers 30 or 34 to create a solution or mixture of liquefied animal waste and sand. As described hereinabove with respect to FIG. 5A-5C, each of the sand separation augers 30 and 34 are configured to rotate within the separation tanks 12 and 14 in a manner that causes the animal waste to be suspended above a lateral flow of sand about tanks 12 and 14. The liquefied animal waste may then be removed from tanks 12 and 14 while the separated sand collects in the dome-shaped portion 12A or 14A of separation tanks 12 and 14. In the illustrated embodiment, the sand separation augers 30 and 34 operate continuously, so mixing of the combination of water and sand/animal waste composition begins as soon as the diverter 24 is controlled to divert the sand/animal waste composition into the tank 12 or 14 being filled. Alternatively, the PLC circuit 160 may be configured to selectively activate and deactivate the augers 30 and 34 by producing appropriate control signals at outputs A10 and A11 respectively.

The control algorithm 250 further includes an independently executing “filled separation tank” control routine 300 having a first step 302 wherein the PLC circuit 160 is operable to monitor the operating torque TQ3, of the sand separation auger 30 or 34 of the recently filled tank 12 or 14. The PLC circuit 160 is operable to execute step 302 by monitoring the torque feedback signal supplied by auger driver 182 or 184 to input S6 or S7, and to determine the operating torque information therefrom as described hereinabove. Thereafter at step 304, the PLC circuit 160 is operable to compare the operating torque value, TQ3 with a torque threshold TQ_{TH3}. If TQ3 is greater than or equal to TQ_{TH3}, control routine 300 loops back to step 302. If, however, the PLC circuit 160 determines at step 304 that TQ3 is less than TQ_{TH3}, the control routine 300 advances to step 306 where PLC circuit 160 is operable to open the liquefied waste outlet valve 190 or 194 to thereby begin removing the liquefied waste from the separation tank 12 or 14. The torque threshold, TQ_{TH3}, is selected to be an operating torque value below which separation of sand from the resulting liquefied waste within the tank 12 or 14 is deemed to be sufficient or adequate. Following step 306, the PLC circuit 160 is operable to monitor the matter level, ML, from the tank 12 or 14 from which the liquefied waste is being removed. The PLC circuit 160 is operable to execute step 308 by monitoring the pressure signal produced by pressure signal 186 or 188, and processing the pressure signal sensor to determine the liquefied matter level within tank 12 or 14. Thereafter at step 310, the PLC circuit 160 is operable to compare ML with a matter level threshold value ML_{TH2}. The matter level threshold, ML_{TH2}, is selected to be a matter level at or below which the quantity of liquefied waste within the tank 12 or 14 is considered to be sufficiently or adequately removed from the tank 12 or 14. If ML is greater than or equal to ML_{TH2}, control routine 300 loops back to step 308. If, on the other hand, ML is less than ML_{TH2}, then the liquefied waste within the tank 12 or 14 is considered to be sufficiently or adequately removed from the tank 12 or 14, and the PLC circuit 160 is operable thereafter at step 312 to close the liquid waste outlet valve 190 or 194.

Following step 312, the control routine 300 advances to step 314 where the PLC circuit 160 is operable to open the water inlet valve 42 or 46 and activate the water pump 172 for a time period T3 and then to close the water inlet valve 42 or 46 and deactivate the water pump 172. This step is included to re-hydrate the sand collected in the bottom dome-shaped portion 12A or 14A of separation tank 12 or 14 to facilitate extracting the collected sand therefrom, and the time period T3 is selected accordingly. Following step 314, the control routine 300 advances to step 316 there the PLC circuit 160 is operable to activate the sand extraction auger 56 or 62 and the sand conveyor 66. Thereafter at step 318, the PLC circuit 160 is operable to monitor the operating torque TQ4, of the sand extraction auger 56 or 62. The PLC circuit 160 is operable to execute step 318 by monitoring the feedback signal supplied by auger driver 198 or auger driver 200, and to process the torque feedback signal information as described hereinabove to determine the operating torque of the sand extraction auger of 56 or 62. Following step 318, the PLC circuit 160 is operable at step 320 to compare the operating torque TQ4 to an operating torque threshold TQ_{TH4}. The torque threshold, TQ_{TH4}, is selected to be an operating torque value below which the quantity of sand within the tank 12 or 14 is deemed to be sufficiently or adequately removed from tank 12 or 14. If TQ4 is greater than or equal to TQ_{TH4}, the control routine 300 loops back to step 318. If, however, the PLC circuit 160 determines that TQ4 is less than TQ_{TH4}, control routine 300 advances to step 322 where the PLC circuit 160 is operable to deactivate the sand extraction auger 56 or 62 and the sand conveyor 66.

For continuous flow operation of system 10, control routines 270 and 300 are coordinated in their time of execution so that one separation tank 12 or 14 is being emptied while the other separation tank 12 or 14 is being filled. In such a continuous flow system, step 284 thus loops directly back to step 272 of control routine 270 and step 322 loops directly back to step 302 of control routine 300. In this embodiment, the system 10 is operable to receive animal waste in the form of a dry or semi-cry composition of animal waste and sand, and to hydrate and separate the composition into liquefied animal waste and bulk sand in a manner that produces a continuous stream of liquefied animal waste and that allows the recovery of bulk sand for reuse in the animal storage facility.

In non-continuous flow operation each of control routines 270 and 300 may require one or more delay steps to coordinate the filling of one tank 12 or 14 with the emptying of the other tank 12 or 14, and/or control algorithm 250 may require one or more additional control routines to control the feed rate of the sand and animal waste composition by the first transport 22 to the separation tanks 12 or 14.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

I claim:

1. A system for processing a composition of sand and animal waste, comprising:
at least one separation tank configured to process the composition by separating the sand from the animal waste;
a first transport configured to supply the composition to the at least one separation tank;
a number of sensors configured to produce sensory information relating to operation of the first transport and operation of the at least one separation tank; and
at least one control circuit configured to monitor the sensory information.

2. The system of claim 1 wherein the at least one control circuit is configured to control the first transport and the at least one separation tank based at least in part on the sensory information.

3. The system of claim 2 further including a number of actuators each responsive to a different actuator control signal to modify operation of one of the first transport and the at least one separation tank;
wherein the at least one control circuit is configured to produce the number of different actuator control signals based at least in part on the sensory information.

4-6. (canceled)

7. The system of claim 3 further including a water source coupled to the at least one separation tank;
and wherein the at least one separation tank is configured to separate the composition into bulk sand and liquefied animal waste.

8. The system of claim 7 wherein each of one or more of the number of actuators is responsive to a corresponding actuator control signal to modify operation of the water source.

9. The system of claim 7 wherein one or more of the number of sensors produces sensory information relating to operation of the water source.

10. The system of claim 1 wherein the at least one separation tank includes separate first and second separation tanks.

11. The system of claim 10 further including a diverter disposed between the first transport and each of the first and second separation tanks, the diverter configured to controllably divert the composition supplied by the first transport to each of the first and second separation tanks.

12. The system of claim 11 further including a diverter actuator responsive to a diverter actuator control signal to selectively divert the composition supplied by the first transport to either of the first separation tank and the second separation tank.

13. The system of claim 12 wherein the at least one control circuit is configured to produce the diverter actuator control signal based on sensory information provided by one or more of the number of sensors.

14. The system of claim 10 wherein each of the first and second separation tanks includes a sand separation auger electrically connected to a sand separation auger driver responsive to a sand separation auger control signal to rotate the sand separation auger within its respective separation tank, the sand separation auger having an auger structure configured to create a lateral flow of the sand within the respective separation tank with the animal waste suspended above the lateral flow of sand.

15. The system of claim 14 wherein the at least one control circuit is configured to produce the sand separation auger control signal based on sensory information provided by one or more of the number of sensors.

16-17. (canceled)

18. The system of claim 14 wherein each of the first and second separation tanks includes a liquid waste outlet port positioned relative to the lateral flow of liquefied animal waste to controllably remove the liquefied animal waste from the respective separation tank.

19-20. (canceled)

21. The system of claim 10 wherein each of the first and second separation tanks includes a sand extraction port coupled to a sand extraction auger electrically connected to a sand extraction auger driver responsive to a sand extraction auger control signal to remove the sand from its respective separation tank.

22. The system of claim 21 wherein the at least one control circuit is configured to produce the sand extraction auger control signal based on sensory information provided by one or more of the number of sensors.

23 (canceled)

24. The system of claim 21 further including a second transport configured to receive the sand from the first and second sand extraction augers and transport the received sand to a sand collection area.

25-26. (canceled)

27. The system of claim 10 wherein one of the number of sensors is a first level sensor producing sensory information indicative of a level of matter within the first separation tank; and
wherein another one of the number of sensors is a second level sensor producing sensory information indicative of a level of matter within the second separation tank.

28-42. (canceled)

43. A method for controlling a system for processing a composition of sand and animal waste, wherein the system includes first and second separation tanks each coupled to a water source and each coupled to a first transport supplying the composition thereto, the method comprising:
directing water from the water source into the first separation tank;
directing the composition supplied by the first transport to the first separation tank;
mixing the composition and the water in the first separation tank in a manner that forms a liquefied animal waste and sand combination, and that separates the sand from the combination to form liquefied animal waste;
removing the liquefied animal waste from the first separation tank; and
extracting the separated sand from the first separation tank.

44. The method of claim 43 wherein the step of directing water from the water source into the first separation tank includes directing a first quantity of water from the water source into the first separation tank.

45. The method of claim 44 wherein the step of directing water from the water source into the first separation tank further includes:
opening a water inlet valve positioned in-line between the first separation tank and the water source;
activating a water pump positioned in-line between the water source and the first separation tank to direct water into the first separation tank;
monitoring a level of the water in the first separation tank; and
deactivating the water pump and closing the water inlet valve when the level of water in the first separation tank reaches a predefined water level.

46. The method of claim 43 wherein the step of directing the composition supplied by the first transport to the first separation tank follows the step of directing water from the water source into the first separation tank and includes directing a second quantity of the composition into the first separation tank.

47. The method of claim 46 wherein the system further includes a composition diverter having an inlet receiving the composition from the first transport, a first outlet and a second outlet, the diverter controllable between a first position coupling the inlet to the first outlet to divert the composition supplied by the first transport to the first separation tank, and a second position coupling the inlet to the second outlet to divert the composition supplied by the transport to the second separation tank;
and wherein the step of directing the composition supplied by the first transport to the first separation tank includes:
controlling the composition diverter to the first position;
monitoring the level of matter within the first separation tank; and
controlling the composition diverter to the second position when the level of matter within the second separation tank reaches a predefined second level.

48. The method of claim 43 wherein the system further includes a rotatable sand separation auger positioned in the first separation tank and configured to create a lateral flow of the sand within the respective separation tank with the animal waste suspended above the lateral flow of sand;
and wherein the step of mixing the composition and the water in the first separation tank includes:
activating the sand separation auger;
monitoring an operating torque of the sand separation auger; and
determining that the sand has been sufficiently separated from the combination when the operating torque of the sand separation auger drops below a separation torque threshold.

49. The method of claim 48 wherein the step of removing the liquefied animal waste from the first separation tank follows the step of mixing the composition and the water in the first separation tank and includes opening a liquefied waste outlet valve when the operating torque of the sand separation auger drops below the first torque threshold.

50. The method of claim 49 wherein the step of removing the liquefied animal waste from the first separation tank includes:
monitoring the level of matter within the first separation tank; and
closing the liquefied waste outlet valve when the level of matter within the first separation tank drops below a threshold matter level.

51. The method of claim 50 wherein the step of removing the sand from the first separation tank includes:
opening a water inlet valve positioned in-line between the first separation tank and the water source;
activating a water pump positioned in-line between the water source and the first separation tank to direct water into the first separation tank; and
deactivating the water pump and closing the water inlet valve upon expiration of a predefined time period following the steps of opening the water inlet valve and activating the water pump.

52. The method of claim 51 wherein the system further includes a sand extraction auger in communication with a sand outlet of the first separation tank;
and wherein the step of removing sand from the first separation tank further includes:
activating the sand extraction auger to extract a combination of sand and water from the first separation tank;
monitoring an operating torque of the sand extraction auger; and
deactivating the sand extraction auger when the operating torque of the sand extraction auger drops below an extraction torque threshold.

53. The method of claim 52 wherein the step of removing sand from the first separation tank further includes:
activating a second transport configured to receive the combination of sand and water extracted from the first separation tank; and
deactivating the second transport when the sand extraction auger is deactivated.

54. The method of claim 43 wherein each of the recited steps is also carried out with respect to the second separation tank.

55. The method of claim 54 wherein control of the system with respect operation of each of the first and second separation tanks is coordinated so that one of the first and second separation tanks is being filled while the other of the first and second separation tanks is being emptied.

56-59. (canceled)
